(19) United States
(12) Patent Application Publication
(10) Pub. No.: US 2017/0047813 A1
(43) Pub. Date: Feb. 16, 2017

(54) DYNAMO

(71) Applicant: HOU WAI GREEN ENERGY MANUFACTURING CO., LTD, Miaoli County (TW)

(72) Inventors: Chin-Hsiang Tang, Taoyuan City (TW); Ching-Hua Liu, Miaoli County (TW)

(21) Appl. No.: 15/228,752

(22) Filed: Aug. 4, 2016

(30) Foreign Application Priority Data
Aug. 14, 2015 (TW) 104126467
Mar. 21, 2016 (TW) 105108634

(51) Int. Cl. H02K 7/10; H02K 16/04; H02K 7/02; H02K 1/16; H02K 1/22

(52) U.S. Cl. CPC H02K 7/1008; H02K 1/16; H02K 1/22; H02K 7/02; H02K 16/04; H02K 2213/03

(57) ABSTRACT

A dynamo is provided. The dynamo includes a rotor and a stator unit. The rotor includes a rotor body and a plurality of magnetic elements, wherein each two adjacent magnetic elements have different magnetic poles. The stator unit includes at least one stator, with the stator including a stator body, a plurality of slots and a plurality of amature windings, wherein the slots are formed on the stator body and face the rotor, the amature windings are wound on the slot, and the slots on the stator body are arranged in a curve and correspond to a portion of the circumferential region of the rotor.

### CROSS REFERENCE TO RELATED APPLICATIONS

This Application claims priority of Taiwan Patent Application No. 105108634, filed on Mar. 21, 2016 and Taiwan Patent Application No. 104126467, filed on Aug. 14, 2015, the entirety of which are incorporated by reference herein.

### BACKGROUND OF THE INVENTION

Field of the Invention

The present invention relates to a dynamo, and in particular to a dynamo with increased power generation efficiency.

Description of the Related Art

Conventional power generators transform kinetic or other energy into electricity. The energy sources thereof can be fuel-driven motors, steam turbines, water turbines, or other devices.

The power generator comprises a stator and a rotor. The rotor comprises a rotor body and a plurality of magnetic elements (permanent magnet or electromagnet) which are arranged sequentially. The stator comprises a stator body, slots, and amature windings. The stator body is made of stacked ferromagnetic material. The slot is formed on the stator body. The amature winding comprises conductive coils. The rotor is rotated to producing a rotating magnetic field. The amature windings generate an induced voltage due to the alternation of the magnetic field. Since the rotor is a magnetic part and the amature windings are inductive structures, a braking force is generated in the magnetic field. Commonly, the braking force consumes the most energy received from the energy sources, and only a small portion of the energy received from the energy sources is used to generate electricity. When the power generator is connected to a load, the load current generated by the power generator produces the braking force. The braking force is increased with the load current. The efficiency of the power generator increases if the braking force effect is decreased.

FIG. 1 shows a conventional six-slot, eight-pole power generator with stator slots arranged in a full circle. The power generator receives kinetic energy from a kinetic energy source (not shown). The power generator comprises a rotor 60 and a stator unit 70. An air gap 76 is formed between the rotor 60 and the stator unit 70. The rotor 60 comprises a rotor body 61 and a plurality of magnetic elements 62. The magnetic elements 62 are sequentially disposed around the rotor body 61. Each two neighboring magnetic elements 62 have different magnetic poles. The stator unit 70 comprises a stator body 73, a plurality of slots 74 and a plurality of amature windings 75 wound on the slots 74. The slots 74 are uniformly formed on the stator body 73 and face the rotor 60. The slots 74 are arranged in an enclosed manner and correspond to a circumferential region 63 of the rotor 60. As shown in FIG. 1, the conventional power generator has six slots 74 and eight magnetic elements 62. The magnetic elements 62 can be permanent magnets or electromagnets. The design using electromagnets can control the magnetic field using an applied current, but it has a complex structure. The design using permanent magnets has a simpler structure, but the magnetic field cannot be controlled. In FIG. 1, the magnetic elements 62 are permanent magnets.

The formula of the frequency of power generator is: f=pn/120, wherein f is the frequency of power generator, p is the number of magnetic elements, and n is the rotating speed of the rotor.

The formula for generating the induced voltage is: E=4.44 KNf, wherein E is the induced voltage, K is the winding factor, N is the number of turns of the armature windings, 41) is the magnetic flux, and f is the frequency of power generator.

In a conventional six-slot, eight-pole power generator with stator slots arranged in a full circle, the circumference of the rotor C₁=πd₁, wherein d₁ is the diameter of the rotor. According to the formulas above, to achieve a frequency of power generator frequency f=50 Hz, the rotor speed n should be 750 rpm, so each slot 74 passes 750×8=6000 magnet elements in one minute. If KNΦof are known, the induced voltage E₁ can be estimated and has a capable power output P₁.

### BRIEF SUMMARY OF THE INVENTION

A dynamo is provided. The dynamo includes a rotor and a stator unit. The rotor includes a rotor body and a plurality of magnetic elements, wherein each two adjacent magnetic elements have different magnetic poles. The stator unit includes at least one stator, with the stator comprising a stator body, a plurality of slots and a plurality of amature windings, wherein the slots are formed on the stator body and face the rotor, the amature windings are wound on the slot, and the slots on the stator body are arranged in a curve and correspond to a portion of the circumferential region of the rotor.

Utilizing the embodiment of the invention, the lifetime of the bearing is extended since the rotation speed and the temperature of the power generator are decreased. Additionally, the noise and the air resistance of the power generator are also reduced.

Utilizing the embodiment of the invention, the slots are arranged in an unenclosed curve, and the power generation efficiency (conversion efficiency) is improved.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a conventional six-slot, eight-pole power generator;

FIG. 2A shows a six-slot, 10-pole power generator of an embodiment of the invention;

FIG. 2B shows a six-slot, 12-pole power generator of an embodiment of the invention;

FIG. 2C shows a six-slot, 16-pole power generator of an embodiment of the invention;

FIG. 2D shows a six-slot, 32-pole power generator of an embodiment of the invention;

FIG. 3A shows a modified example of the power generator of the embodiment of FIG. 2D;

FIG. 3B shows another modified example of the power generator of the embodiment of FIG. 2D;

FIG. 4A shows a three-slot, six-pole power generator of an embodiment of the invention;

FIG. 4B shows a nine-slot, 28-pole power generator of an embodiment of the invention;

FIG. 4C shows a nine-slot, 32-pole power generator of an embodiment of the invention;

FIG. 5A shows a modified example of the power generator of an embodiment of the invention;

FIG. 5B shows another modified example of the power generator of an embodiment of the invention;

FIG. 5C shows another modified example of the power generator of an embodiment of the invention;

FIG. 6A shows a dynamo of an embodiment of the invention;

FIG. 6B shows another dynamo of an embodiment of the invention;

FIG. 6C shows another dynamo of an embodiment of the invention;

FIG. 6D shows another dynamo of an embodiment of the invention;

FIG. 6E shows another dynamo of an embodiment of the invention;

FIG. 7A shows a dynamo of an embodiment of the invention;

FIG. 7B shows another dynamo of an embodiment of the invention;

FIG. 8 shows a transmission wheel set of an embodiment of the invention; and

FIG. 9 shows a detachable stator of an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

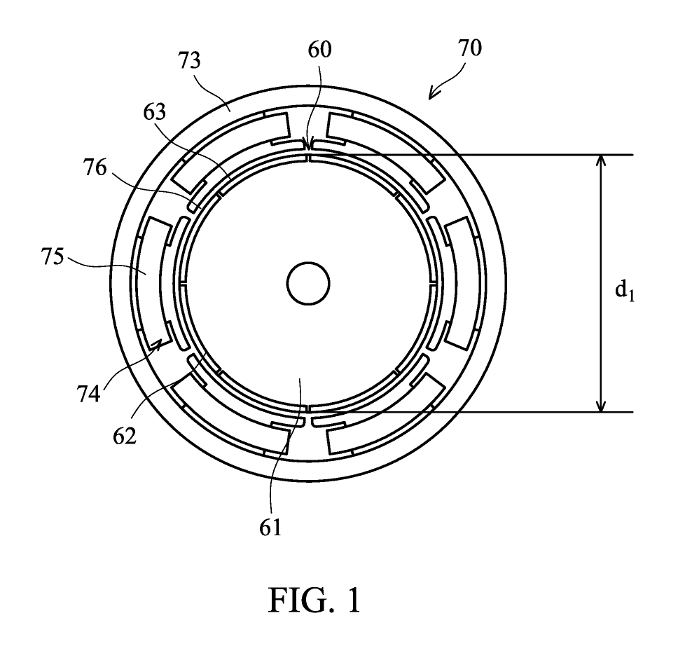

In the following four embodiments, only the magnetic element number and the rotor speed are changed with the rotor diameter to clarify the description. In the frequency formula of power generator f=pn/120, the frequency of power generator f remains 50 Hz. The number of magnetic elements p is changed with the rotating speed of the rotor n. The other parameters such as the amature winding dimensions, the turns and methods of amature winding, the size of the air gap, the magnetic element dimensions, the amount of slot, the magnetic flux of amature winding and the slots of the stator are corresponding to the number of the magnetic elements of the rotor remain unchanged. In other words, in the induced voltage formula E=4.44 KNV, the winding factor K, the armature winding turns N, the magnetic flux Φ and the frequency of power generator f are unchanged. In the following four embodiments, the frequency of power generator f, the winding factor K, the armature winding turns N and the magnetic flux Φ is the same as the design of the conventional power generator of FIG. 1.

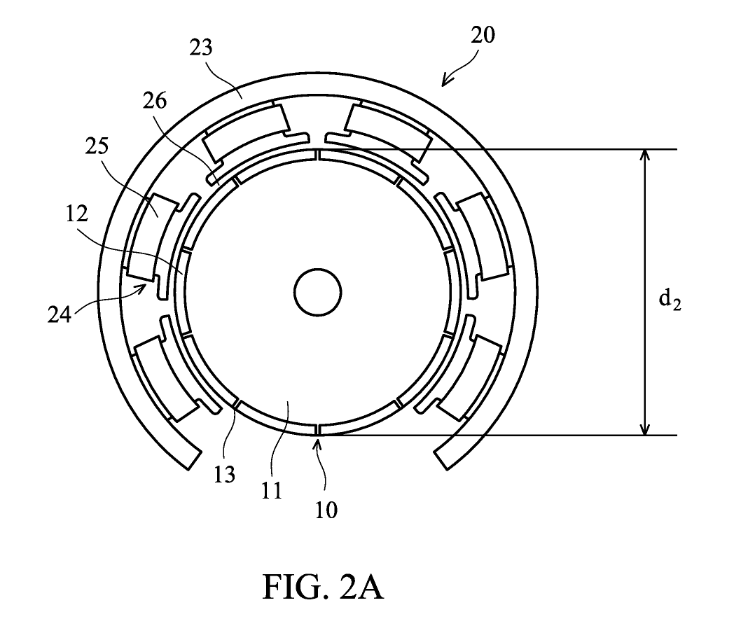

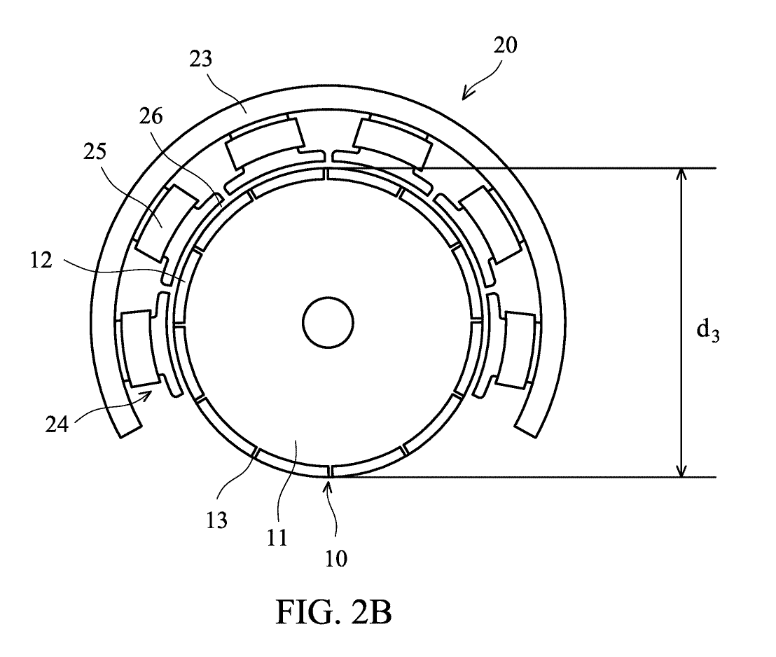

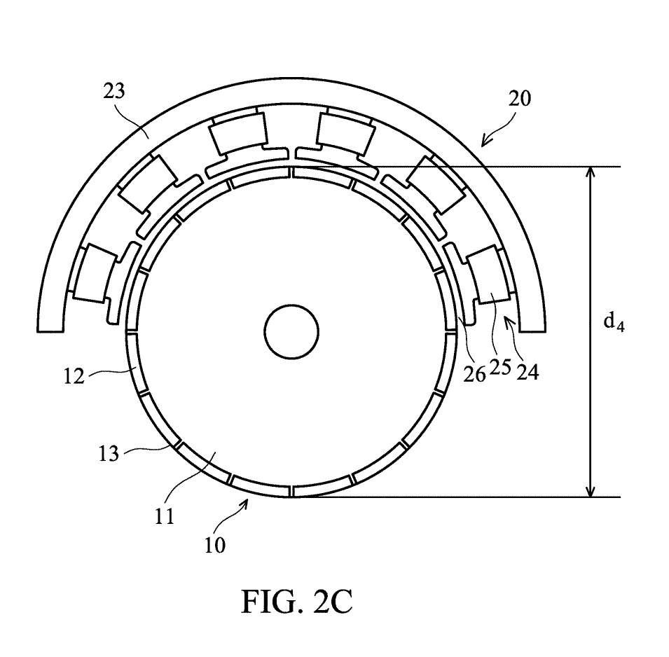

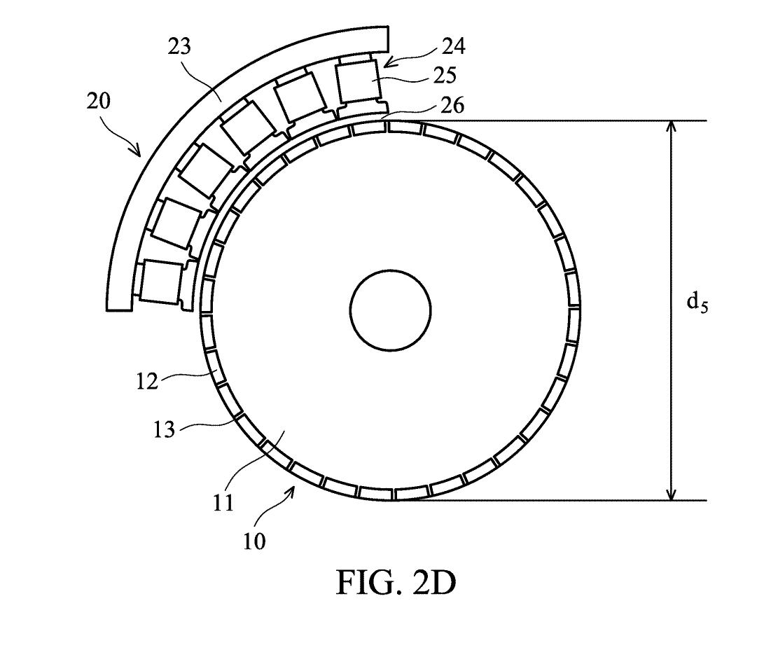

FIG. 2A shows a six-slot, ten-pole power generator with an unenclosed arrangement of stator slots of an embodiment of the invention. The power generator receives kinetic energy from a kinetic energy source (not shown). The power generator comprises a rotor 10 and a stator unit 20. An air gap 26 is formed between the rotor 10 and the stator unit 20. The rotor 10 comprises a rotor body 11 and a plurality of magnetic elements 12. The magnetic elements 12 are sequentially disposed around the rotor body 11. Each two adjacent magnetic elements 12 have different magnetic poles. The stator unit 20 comprises a stator body 23, a plurality of slots 24 and a plurality of amature windings 25 wound on the slots 24. The slots 24 are uniformly formed on the stator body 23 and face the rotor 10. The slots 24 are arranged in an unenclosed curve and correspond to a circumferential region 13 of the rotor 10. In this embodiment, the power generator has six slots 24 and ten magnetic elements 12.

Compared to the conventional power generator of FIG. 1, the rotor 10 has a larger diameter, the number of magnetic elements 12 is increased, and the diameter d₂ of the rotor 10 is 1.25 times d₁ (d₂=1.25d₁). The area of the slots 24 on the stator body 23 corresponding to the rotor 10 is corresponding to about four-fifths of the circumferential region 13 of the rotor 10, and the remaining one-fifths of the circumferential region 13 of the rotor 10 is not corresponded. In this embodiment, the stator body 23 is arranged with the area of the slots 24 is the same with the conventional slot 74 of the stator body 73 arranged as a full-circle, which is corresponding to eight magnetic elements 12. According to the formulas above, to achieve a frequency of power generator f=50 Hz, the rotor 10 rotating speed n should be 600 rpm, so each slot 24 passes 10×600=6000 magnet elements 12 in one minute. Compared to the conventional power generator of FIG. 1, the induced voltage E₁ and the capable power output P₁ of this embodiment is the same as that of the conventional power generator of FIG. 1. However, in the embodiment of the invention, the slots 24 only correspond to a portion of the circumferential region 13 of the rotor 10. There is no braking force between a portion of the rotor 10 and the stator unit 20. Additionally, the rotating speed of the rotor 10 is decreased, and the kinetic energy consumption from the kinetic energy source is decreased. Therefore, the embodiment of the invention improves the power generation efficiency (conversion efficiency).

FIG. 2B shows a six-slot, twelve-pole power generator with stator slots in an unenclosed arrangement of an embodiment of the invention. The power generator receives kinetic energy from a kinetic energy source (not shown). The power generator comprises a rotor 10 and a stator unit 20. An air gap 26 is formed between the rotor 10 and the stator unit 20. The rotor 10 comprises a rotor body 11 and a plurality of magnetic elements 12. The magnetic elements 12 are sequentially disposed around the rotor body 11. Each two adjacent magnetic elements 12 have different magnetic poles. The stator unit 20 comprises a stator body 23, a plurality of slots 24 and a plurality of amature windings 25 wound on the slots 24. The slots 24 are uniformly formed on the stator body 23 and face the rotor 10. The slots 24 are arranged in an unenclosed curve and correspond to a circumferential region 13 of the rotor 10. In this embodiment, the power generator has six slots 24 and twelve magnetic elements 12.

Compared to the conventional power generator of FIG. 1, the rotor 10 has a larger diameter, the number of magnetic elements 12 is increased, and the diameter d₃ of the rotor 10 is 1.5 times d₁ (d₃=1.5d₁). The area of the slots 24 on the stator body 23 corresponding to the rotor 10 is corresponding to about two-thirds of the circumferential region 13 of the rotor 10, and the remaining one-thirds of the circumferential region 13 of the rotor 10 is not corresponded. In this embodiment, the stator body 23 is arranged with the area of the slots 24 is the same with the conventional slot 74 of the stator body 73 arranged as a full-circle, which is corresponding to eight magnetic elements 12. According to the formulas above, to achieve an power generator frequency f=50 Hz, the rotor 10 rotating speed n should be 500 rpm, so each slot 24 passes 12×500=6000 magnet elements 12 in one minute. Compared to the conventional power generator of FIG. 1, the induced voltage E₁ and the capable power output P₁ of this embodiment is the same as that of the conventional power generator of FIG. 1.

FIG. 2C shows a six-slot, sixteen-pole power generator with stator slots in an unenclosed arrangement of an embodiment of the invention. The power generator receives kinetic energy from a kinetic energy source (not shown). The power generator comprises a rotor 10 and a stator unit 20. An air gap 26 is formed between the rotor 10 and the stator unit 20. The rotor 10 comprises a rotor body 11 and a plurality of magnetic elements 12. The magnetic elements 12 are sequentially disposed around the rotor body 11. Each two adjacent magnetic elements 12 have different magnetic poles. The stator unit 20 comprises a stator body 23, a plurality of slots 24 and a plurality of amature windings 25 wound on the slots 24. The slots 24 are uniformly formed on the stator body 23 and face the rotor 10. The slots 24 are arranged in an unenclosed curve and correspond to a circumferential region 13 of the rotor 10. In this embodiment, the power generator has six slots 24 and sixteen magnetic elements 12.

Compared to the conventional power generator of FIG. 1, the rotor 10 has a larger diameter, the number of magnetic elements 12 is increased, and the diameter d₄ of the rotor 10 is 2 times d₁ (d₄=2d₁). The area of the slots 24 on the stator body 23 corresponding to the rotor 10 is half of the circumferential region 13 of the rotor 10, and the remaining half of the circumferential region 13 of the rotor 10 is not corresponded. In this embodiment, the stator body 23 is arranged with the area of the slots 24 is the same with the conventional slot 74 of the stator body 73 arranged as a full-circle, which is corresponding to eight magnetic elements 12. According to the formulas above, to achieve a frequency of power generator f=50 Hz, the rotor 10 rotating speed n should be 375 rpm, so each slot 24 passes 16×375=6000 magnet elements 12 in one minute. Compared to the conventional power generator of FIG. 1, the induced voltage E₁ and the capable power output P₁ of this embodiment is the same as that of the conventional power generator of FIG. 1.

FIG. 2D shows a six-slot, 32-pole power generator with an unenclosed arrangement of stator slots of an embodiment of the invention. The power generator comprises a rotor 10 and a stator unit 20. An air gap 26 is formed between the rotor 10 and the stator unit 20. The rotor 10 comprises a rotor body 11 and a plurality of magnetic elements 12. The magnetic elements 12 are sequentially disposed around the rotor body 11. Each two adjacent magnetic elements 12 have different magnetic poles. The stator unit 20 comprises a stator body 23, a plurality of slots 24 and a plurality of amature windings 25 wound on the slots 24. The slots 24 are formed on the stator body 23 and face the rotor 10. The slots 24 are arranged in an unenclosed curve and correspond to a circumferential region 13 of the rotor 10. In this embodiment, the power generator has six slots 24 and thirty-two magnetic elements 12.

Compared to the conventional power generator of FIG. 1, the rotor 10 has a larger diameter, the number of magnetic elements 12 is increased, and the diameter d₅ of the rotor 10 is 4 times d₁ (d₅=4d₁). The area of the slots 24 on the stator body 23 corresponding to the rotor is quarter of the circumferential region 13 of the rotor 10, and the remaining three-fourths of the circumferential region 13 of the rotor 10 is not corresponded. In this embodiment, the stator body 23 is arranged with the area of the slots 24 is the same with the conventional slot 74 of the stator body 73 arranged as a full-circle, which is corresponding to eight magnetic elements 12. According to the formulas above, to achieve a frequency of power generator f=50 Hz, the rotor speed n should be 187.5 rpm, so each slot 24 passes 32×187.5=6000 magnet elements 12 in one minute. Compared to the conventional power generator of FIG. 1, the induced voltage E₁ and the capable power output P₁ of this embodiment is the same as that of the conventional power generator of FIG. 1.

As mentioned above, in the embodiment of the invention, the slots 24 only correspond to a portion of the circumferential region 13. There is no braking force between a portion of the rotor 10 and the stator unit 20. Additionally, the rotating speed of the rotor 10 is decreased, and the kinetic energy consumption from the kinetic energy source is decreased. Therefore, the embodiment of the invention improves the power generation efficiency (conversion efficiency).

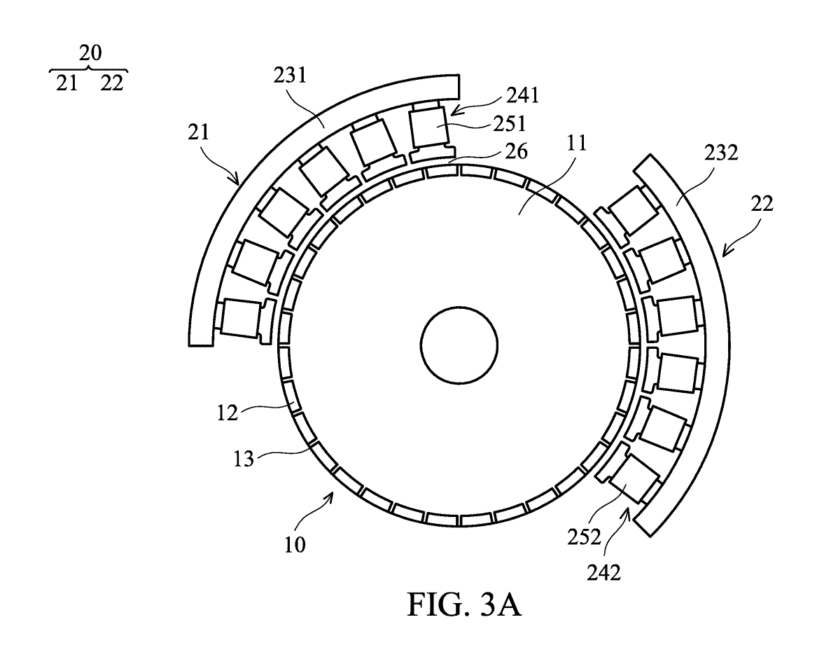

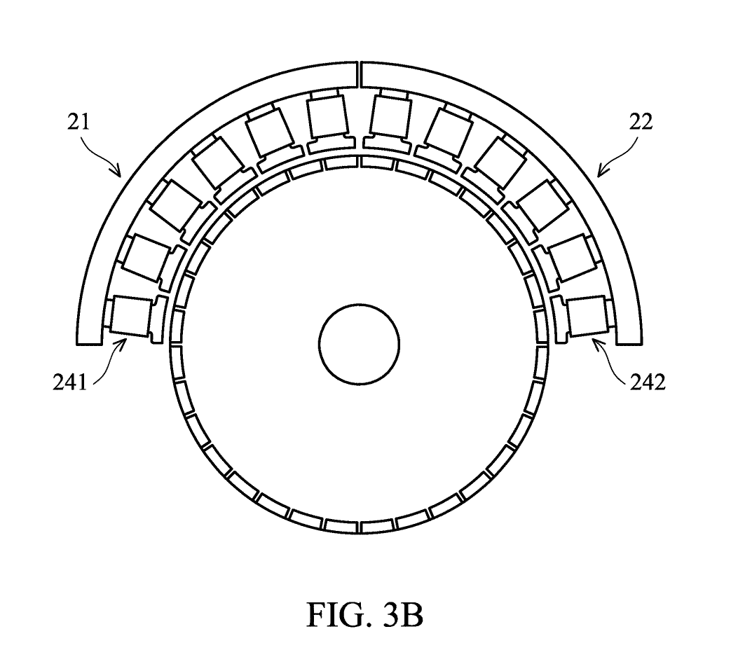

FIG. 3A shows a 12-slot, 32-pole power generator with an unenclosed arrangement of stator slots of an embodiment of the invention. The power generator comprises a rotor 10 and a stator unit 20. An air gap 26 is formed between the rotor 10 and the stator unit 20. The rotor 10 comprises a rotor body 11 and a plurality of magnetic elements 12. The magnetic elements 12 are sequentially disposed around the rotor body 11. Each two adjacent magnetic elements 12 have different magnetic poles.

The stator unit 20 comprises a first stator 21 and a second stator 22. The first stator 21 comprises a first stator body 231, a plurality of first slots 241 and a plurality of first amature windings 251 wound on the first slots 241. The second stator 22 comprises a second stator body 232, a plurality of second slots 242 and a plurality of second amature windings 252 wound on the second slots 242. The first slots 241 are formed on the first stator body 231 and face the rotor 10. The second slots 242 are formed on the second stator body 232 and face the rotor 10. The first slots 241 on the first stator body 231 are arranged in an unenclosed curve. The second slots 242 on the second stator body 232 are arranged in an unenclosed curve. The first slots 241 of the first stator body 231 are arranged in non-enclosed arc. The second slots 242 of the second stator body 232 are arranged in non-enclosed arc. The area of the first slots 241 of the first stator 21 corresponding to the rotor 10 is quarter of the circumferential region 13 of the rotor 10. The area of the second slots 242 of the second stator 22 corresponding to the rotor is quarter of the circumferential region 13 of the rotor 10. The first slots 241 and the second slots 242 are interval with the magnetic elements 12. The power generator has twelve slots (241, 242) and thirty-two magnetic elements 12. Four magnetic elements 12 are located between the first slot 241 and the second slot 242. The embodiment of FIG. 3A differs from the embodiment of FIG. 2D in that the slots (241, 242) are arranged in intervals with increased amature windings (251, 252) to increase output power. The stator unit 20 comprises the first stator 21 and the second stator 22. The first slot 241 and the second slot 242 are corresponding to a portion of the circumferential region 13 of the rotor 10. The area of the first slots 241 of the first stator corresponding to the rotor is smaller than half of the circumferential region 13 of the rotor 10. The area of the second slots 242 of the second stator corresponding to the rotor is smaller than half of the circumferential region 13 of the rotor 10. The slots (241, 242) of the stators (21,22) are arranged in two unenclosed curves, and a perimeter sum of projection areas of the slots (241, 242) of the stators (21,22) on the circumferential region of the rotor 10 is smaller than the perimeter of the circumferential region 13 of the rotor 10. In the embodiment, the slots (241, 242) corresponds half of the circumferential region of the rotor 10. Additionally, the kinetic energy consumption from a kinetic energy source is decreased. Therefore, the embodiment of the invention improves the power generation efficiency.

FIG. 3B shows a 12-slot, 32-pole power generator with an unenclosed arrangement of stator slots of an embodiment, which is similar to the embodiment of FIG. 3A. The embodiment of FIG. 3B differs from the embodiment of FIG. 3A in that the first slots 241 of the first stator 21 are next to the second slots 242 of the second stator 22.

As shown in FIGS. 3A and 3B, the slots can be adjacent to each other or arranged at intervals. A perimeter sum of the slots of the stator corresponding to the circumferential region of the rotor is smaller than the perimeter of the rotor. In other words, a perimeter sum of projection areas of the slots of the stator on the circumferential region of the rotor is smaller than the perimeter of the circumferential region of the rotor.

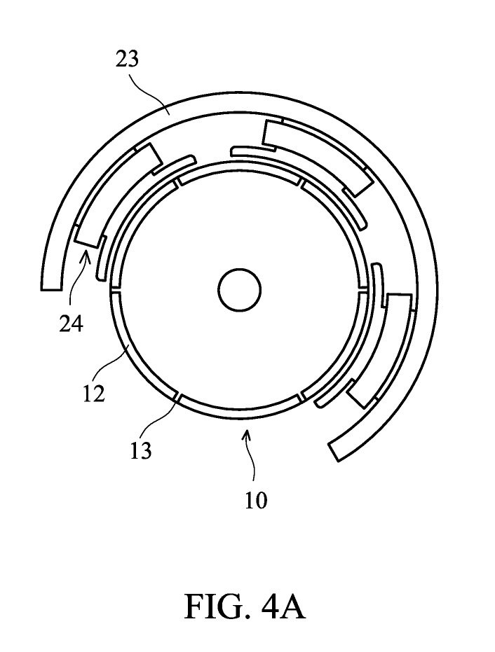

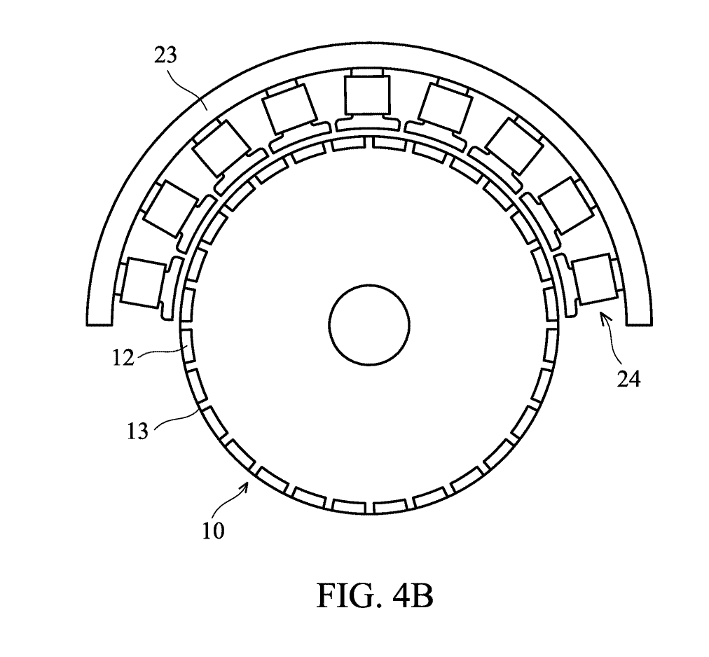

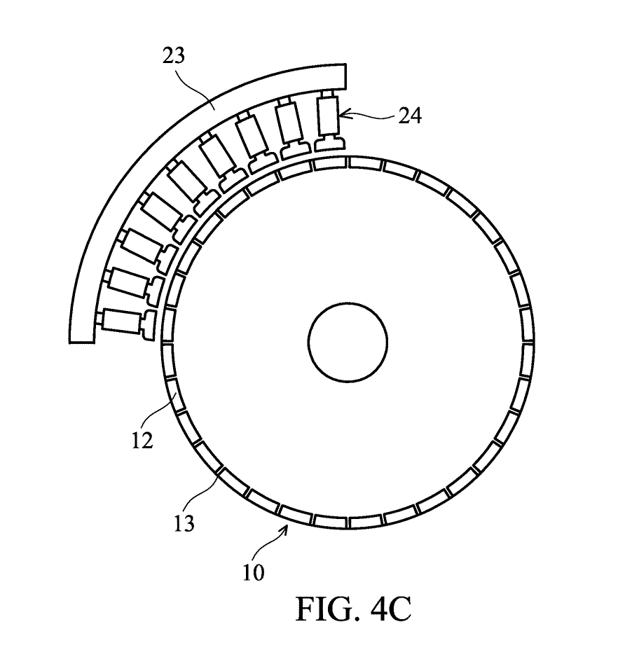

FIG. 4A shows a three-slot, six-pole power generator with an unenclosed arrangement of stator slots of an embodiment of the invention. Similar to the embodiments above, the slots 24 are formed on the stator body 23 and face the rotor 10. In the embodiment of FIG. 4A, the area of the slots 24 on the stator body 23 corresponding to the rotor 10 is two-thirds of the circumferential region 13 of the rotor 10 (four magnetic elements 12).

FIG. 4B shows a nine-slot, 28-pole power generator with an unenclosed arrangement of stator slots of an embodiment of the invention. Similar to the embodiments above, the slots 24 are formed on the stator body 23 and face the rotor 10. In the embodiment of FIG. 4B, the area of the slots 24 on the stator body corresponding to the rotor is half of the circumferential region 13 of the rotor 10 (fourteen magnetic elements 12).

FIG. 4C shows a nine-slot, 32-pole power generator with an unenclosed arrangement of stator slots of an embodiment of the invention. Similar to the embodiments above, the slots 24 are formed on the stator body 23 and face the rotor 10. In the embodiment of FIG. 4C, the area of the slots 24 on the stator body corresponding to the rotor is quarter of the circumferential region 13 of the rotor 10 (eight magnetic elements 12).

As shown in the embodiments of FIGS. 4A to 4C, the number of slots and poles can be modified. When the number of slots is similar to the number of poles, the flux utilization is improved. In other words, the difference between the number of slots and the number of poles is less than or equal to six, and the flux utilization is improved. In a preferred embodiment, the difference between the number of slots and the number of magnetic elements is less than or equal to six (|number of slots˜number of poles|≦6)

As shown above, the power generator of the embodiment can be a single-phase power generator or a three-phase power generator.

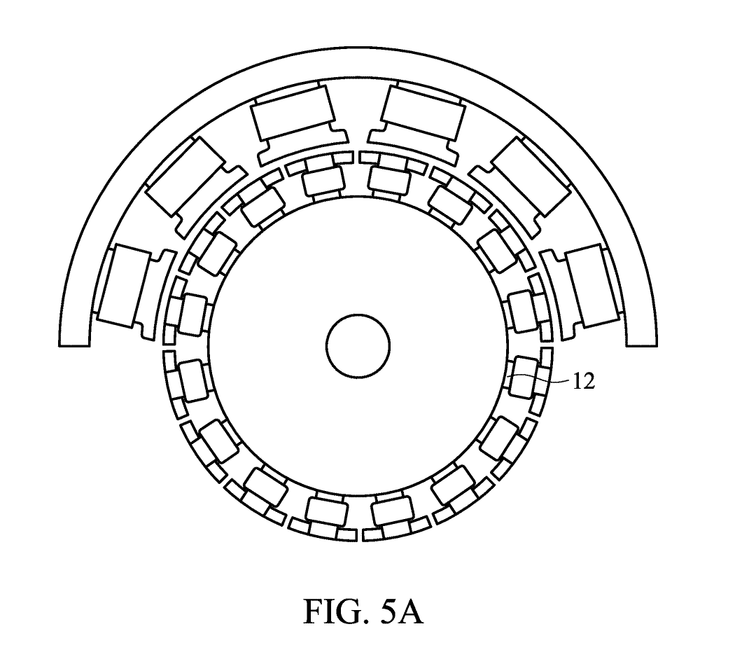

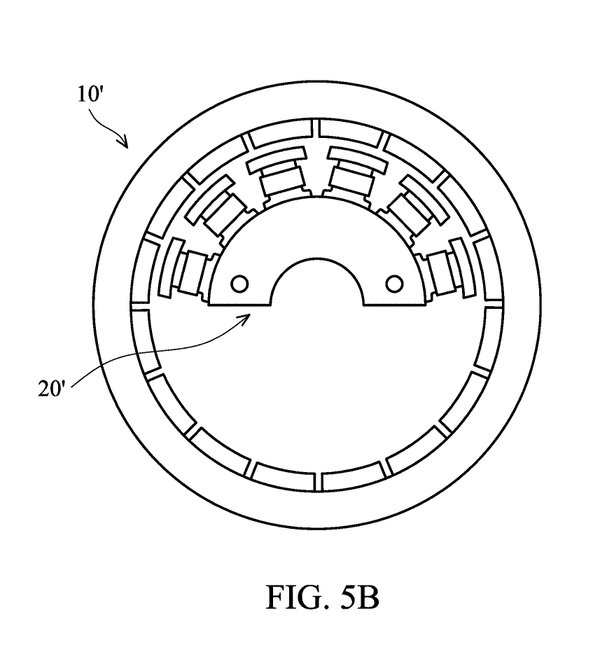

FIG. 5 shows a power generator with stator slots in an unenclosed arrangement, wherein the magnetic elements 12 are electromagnetic (excitation winding excited) elements, and neighboring electromagnets have opposite poles.

Additionally, the slots and the rotor can be oppositely arranged. Refer to FIG. 5B, wherein the rotor 10′ surrounds the unenclosed slots 20′.

FIG. 5C shows a six-slot, 16-pole power generator with an unenclosed arrangement of stator slots of an embodiment of the invention, similar to the embodiments of FIG. 2C. In the embodiment of FIG. 5C, the stator body 23 is enclosed arranged. The slots 24 are arranged in an unenclosed curve and correspond to the circumferential region 13 of the rotor 10.

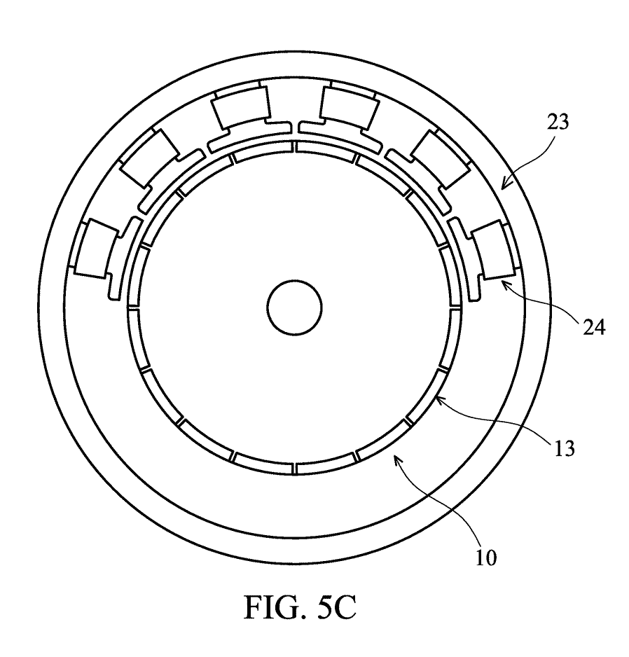

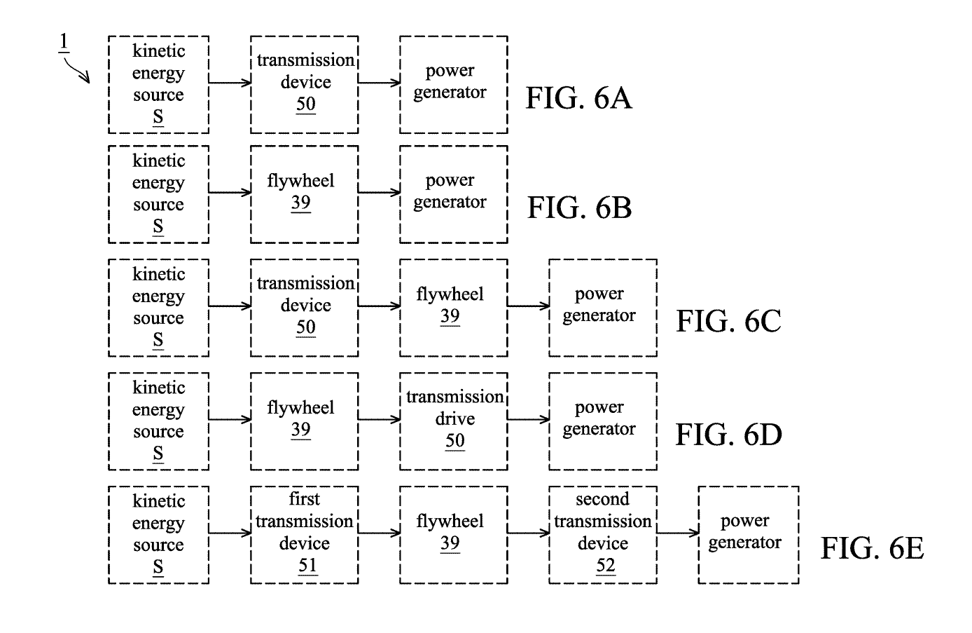

FIG. 6A shows a dynamo 1 of an embodiment of the invention, comprising a kinetic energy source S, a transmission device 50 and a power generator with an unenclosed arrangement of stator slots. The transmission device 50 is connected to the kinetic energy source S and drove thereby. The power generator is connected to the transmission device 50 and drove thereby. The transmission device 50 modifies rotation speed to drive the power generator according to the design of the power generator.

FIG. 6B shows a dynamo 1 of an embodiment of the invention, comprising a kinetic energy source S, a flywheel 39 and a power generator with an unenclosed arrangement of stator slots. The flywheel 39 is connected to the kinetic energy source S and drove thereby. The power generator is connected to the flywheel 39 and drove thereby. The flywheel 39 previously stores power to overcome the energy requirement of the Instantaneous load change of the stator slot non-full-circle generator to reduce the variation of the rotation speed and to smoothen the rotation.

FIG. 6C shows a dynamo 1 of an embodiment of the invention, comprising a kinetic energy source S, a transmission device 50, a flywheel 39 and a power generator with an unenclosed arrangement of stator slots. The transmission device 50 is connected to the kinetic energy source S and drove thereby. The flywheel 39 is connected to the transmission device 50 and drove thereby. The power generator is connected to the flywheel 39 and drove thereby.

FIG. 6D shows a dynamo 1 of an embodiment of the invention, comprising a kinetic energy source S, a flywheel 39, a transmission device 50 and a power generator with an unenclosed arrangement of stator slots. The flywheel 39 is connected to the kinetic energy source S and drove thereby. The transmission device 50 is connected to the flywheel 39 and drove thereby. The power generator is connected to the transmission device 50 and drove thereby.

FIG. 6E shows a dynamo 1 of an embodiment of the invention, comprising a kinetic energy source S, a first transmission device 51, a flywheel 39, a second transmission device 52 and a power generator with an unenclosed arrangement of stator slots. The first transmission device 51 is connected to the kinetic energy source S and drove thereby. The flywheel 39 is connected to the first transmission device 51 and drove thereby. The second transmission device 52 is connected to the flywheel 39 and drove thereby. The power generator is connected to the second transmission device 52 and drove thereby. The first transmission device 51 modifies the rotation speed and the torque to drive the flywheel 39. The second transmission device 52 modifies the rotation speed to rotate the power generator according to the design of the power generator.

As shown in the embodiments of FIGS. 6A to 6E, the transmission device and the flywheel can be add to or removed from the dynamo. The transmission device modifies the rotation speed and the torque, and the flywheel previously stores kinetic energy to overcome instantaneousl load change of the power generator, reduces speed variation, and smoothes the rotation of the power generator. The transmission device modifies the rotation speed and the torque. The flywheel previously stores power to reduce the variation of the rotation speed of the power generator.

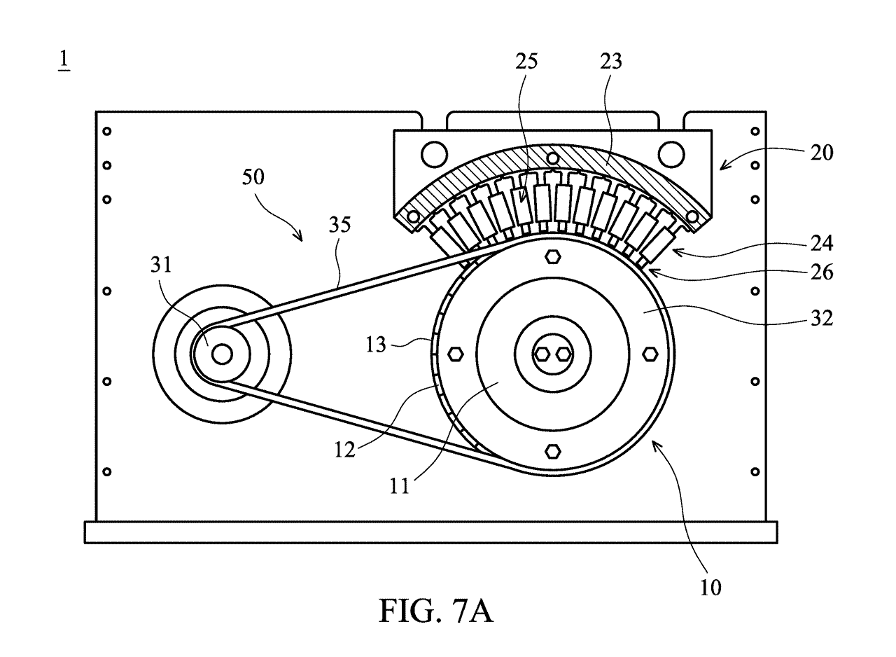

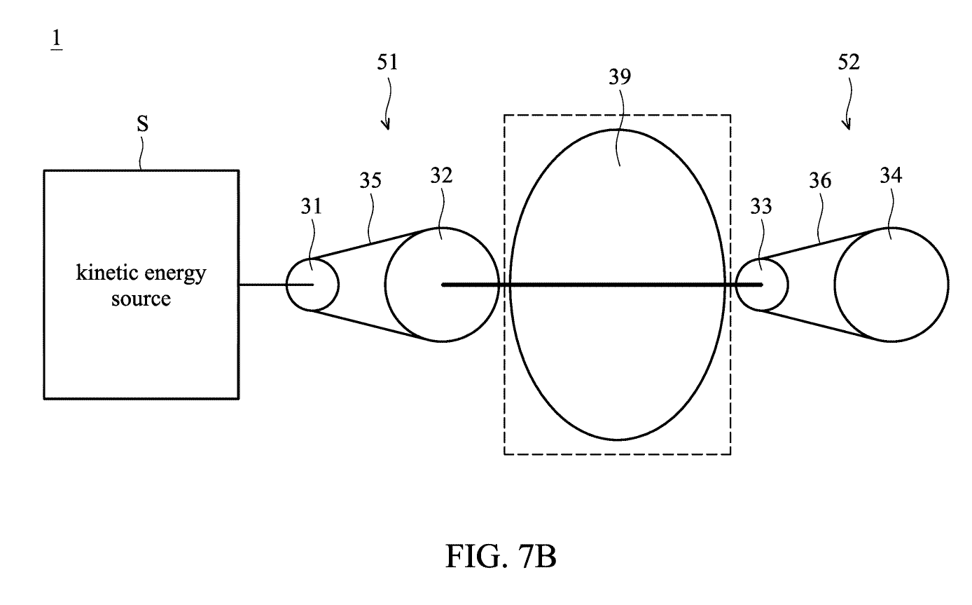

FIG. 7A shows detailed structure of the dynamo 1 of the embodiment of FIG. 6A. The dynamo 1 receives kinetic energy from a kinetic energy source (not shown). The dynamo 1 comprises a power generator with an unenclosed arrangement of stator slots. The power generator comprises a rotor 10 and a stator unit 20. An air gap 26 is formed between the rotor 10 and the stator unit 20. The rotor 10 comprises a rotor body 11 and a plurality of magnetic elements 12. Each two adjacent magnetic elements 12 have different magnetic poles. The stator unit 20 comprises a stator body 23, a plurality of slots 24 and a plurality of amature windings 25 wound on the slots 24. The slots 24 are arranged in an unenclosed curve and correspond to a circumferential region 13 of the rotor 10.

With reference to FIG. 7A, in this embodiment, the dynamo 1 further comprises a transmission device 50, which can be a gearset transmission device or a wheel transmission device. In this embodiment, the transmission device 50 is a wheel transmission device. The transmission device 50 comprises a first wheel 31, a second wheel 32 and a first belt 35. The first wheel 31 is connected to the kinetic energy source and is rotated thereby. The second wheel 32 is connected to the rotor 10. The first belt 35 is connected to the first wheel 31 and the second wheel 32 to transmit the kinetic energy from the first wheel 31 to the second wheel 32. The second wheel 32 is coaxially connected to the rotor 10.

In the Embodiment of FIG. 7A, the diameter of the first wheel 31 is smaller than that of the second wheel 32. In one preferred embodiment, the diameter of the second wheel 32 is greater than twice the diameter of the first wheel 31. For example, the diameter of the second wheel 32 can be 3-6 times the diameter of the first wheel 31. The diameter of the first wheel 31 being smaller than that of the second wheel 32 can decrease the rotation speed and increase the torque, which transforms the rotation speed and the torque of the kinetic energy source (for example, a motor) between the first wheel 31 and the second wheel 32. Therefore, the rotation speed of the first wheel 31 is greater than that of the second wheel 32. Utilizing the embodiment of the invention, the slots 24 only correspond to a portion of the circumferential region 13. Therefore, the embodiment of the invention improves the power generation efficiency (conversion efficiency).

FIG. 7B shows detailed structure of the dynamo 1 of the embodiment of FIG. 6E. The dynamo 1 receives kinetic energy from a kinetic energy source S. The dynamo 1 comprises a first transmission device 51, a flywheel 39, a second transmission device 52 and a power generator with an unenclosed arrangement of stator slots (not shown). The first transmission device 51 comprises a first wheel 31, a second wheel 32 and a first belt 35. The second transmission device 52 comprises a third wheel 33, a fourth wheel 34 and a second belt 36. The first wheel 31 is connected to the kinetic energy source (for example, a motor) and is rotated thereby. The first belt 35 is connected to the first wheel 31 and the second wheel 32 to transmit the kinetic energy from the first wheel 31 to the second wheel 32. The flywheel 39 is connected to the second wheel 32. The third wheel 33 is connected to the flywheel 39. The fourth wheel 34 is connected to the rotor (not shown). The second belt 36 is connected to the third wheel 33 and the fourth wheel 34 to transmit the kinetic energy from the third wheel 33 to the fourth wheel 34. The fourth wheel 34 rotates the rotor. In one embodiment, the fourth wheel 34 is coaxially connected to the rotor.

In the Embodiment of FIG. 7B, the diameter of the first wheel 31 is smaller than that of the second wheel 32, and the diameter of the third wheel 33 is smaller than that of the fourth wheel 34. In one preferred embodiment, the diameter of the second wheel 32 is greater than twice the diameter of the first wheel 31, and the diameter of the fourth wheel 34 is greater than twice the diameter of the third wheel 33. For example, the diameter of the second wheel 32 can be 3-6 times the diameter of the first wheel 31, and the diameter of the fourth wheel 34 can be 3-6 times the diameter of the third wheel 33.

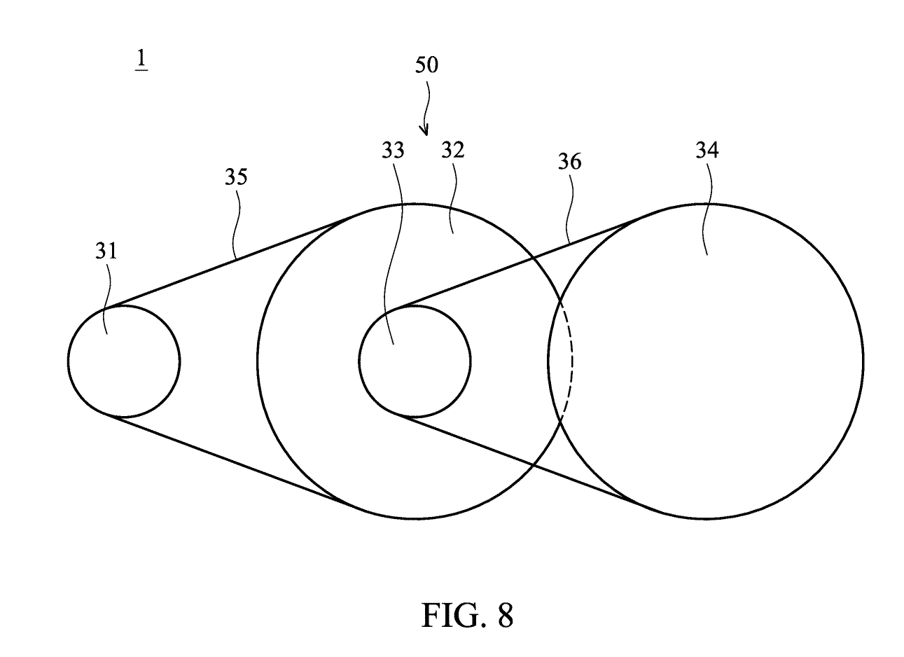

FIG. 8 shows a modified embodiment of FIG. 7B. The dynamo 1 comprises a transmission device 50, which comprises a first wheel 31, a second wheel 32, a first belt 35, a third wheel 33, fourth wheel 34 and a second belt 36. The first wheel 31 is connected to the kinetic energy source (not shown) and is rotated thereby. The first belt 35 is connected to the first wheel 31 and the second wheel 32 to transmit the kinetic energy from the first wheel 31 to the second wheel 32. The third wheel 33 is coaxially disposed on the second wheel 32. The fourth wheel 34 is connected to the rotor (not shown). The second belt 36 is connected to the third wheel 33 and the fourth wheel 34 to transmit the kinetic energy from the third wheel 33 to the fourth wheel 34. The fourth wheel 34 rotates the rotor. In one embodiment, the fourth wheel 34 is coaxially connected to the rotor.

In the Embodiment of FIG. 8, the diameter of the first wheel 31 is smaller than that of the second wheel 32, and the diameter of the third wheel 33 is smaller than that of the fourth wheel 34. In one preferred embodiment, the diameter of the second wheel 32 is greater than twice the diameter of the first wheel 31, and the diameter of the fourth wheel 34 is greater than twice the diameter of the third wheel 33. For example, the diameter of the second wheel 32 can be 3-6 times the diameter of the first wheel 31, and the diameter of the fourth wheel 34 can be 3-6 times the diameter of the third wheel 33.

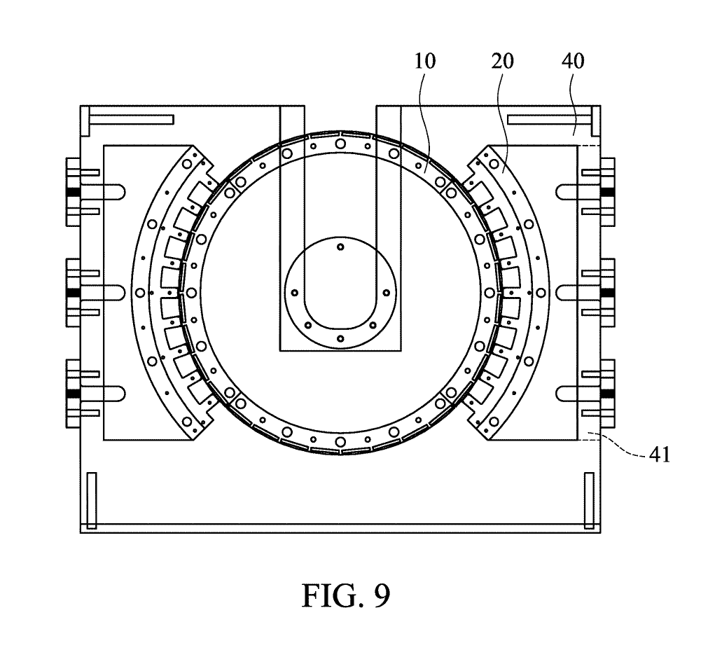

FIG. 9 shows a dynamo of an embodiment of the invention, wherein the dynamo comprises a housing 40. The rotor 10 is disposed in the housing 40. The stator unit 20 is detachably disposed in the housing 40. The stator unit 20 is inserted into the housing 40 and corresponds to the rotor 10. The housing 40 comprises a detachable groove 41, the stator unit 20 is inserted into the detachable groove 41, and the stator unit 20 is affixed to the housing 40.

Utilizing the embodiment of the invention, the lifetime of the bearing is extended since the rotation speed and the temperature of the power generator are decreased. Additionally, the noise and the air resistance of the power generator are also reduced.

Utilizing the embodiment of the invention, the slots are arranged in an unenclosed curve, and the power generation efficiency (conversion efficiency) is improved.

In the embodiments of the invention, the conversion ratio of the transmission device depends on the rotation speed required according to the design of the rotor and the stator.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term).

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A dynamo, comprising:
a rotor, comprising a rotor body and a plurality of magnetic elements, wherein each two adjacent magnetic elements have different magnetic poles; and
a stator unit, comprising at least one stator, the stator comprising a stator body, a plurality of slots and a plurality of amature windings, wherein the slots are formed on the stator body and face the rotor, the amature windings are wound on the slot, and the slots on the stator body are arranged in a curve and correspond to a portion of the circumferential region of the rotor.

2. The dynamo as claimed in claim 1, wherein the area of the slots on the stator body corresponding to the rotor is less than or equal to four-fifths of the circumferential region of the rotor.

3. The dynamo as claimed in claim 1, wherein the area of the slots on the stator body corresponding to the rotor is less than or equal to two-thirds of the circumferential region of the rotor.

4. The dynamo as claimed in claim 1, wherein the area of the slots on the stator body corresponding to the rotor is less than or equal to half of the circumferential region of the rotor.

5. The dynamo as claimed in claim 1, wherein the area of the slots on the stator body corresponding to the rotor is less than or equal to quarter of the circumferential region of the rotor.

6. The dynamo as claimed in claim 1, wherein the stator unit comprises a first stator and a second stator, the first stator comprises a first stator body, a plurality of first slots and a plurality of first amature windings, the second stator comprises a second stator body, a plurality of second slots and a plurality of second amature windings, wherein the first slots are formed on the first stator body and face the rotor, the first amature windings are wound on the first slot, the second slots are formed on the second stator body and face the rotor, the second amature windings are wound on the second slot, the first slots on the first stator body are arranged in a curve, the second slots on the second stator body are arranged in a curve, the area of the first slots of the first stator corresponding to the rotor is smaller than half of the circumferential region of the rotor, and the area of the second slots of the second stator corresponding to the rotor is smaller than half of the circumferential region of the rotor.

7. The dynamo as claimed in claim 6, wherein the first slots of the first stator and the second slots of the second stator are neighboring arranged or arranged in intervals.

8. The dynamo as claimed in claim 1, wherein the stator unit comprises a plurality of stators, the slots of the stators are arranged in an unenclosed curve, and a perimeter sum of projection areas of the slots of the stator on the circumferential region of the rotor is smaller than a perimeter of the circumferential region of the rotor.

9. The dynamo as claimed in claim 1, wherein the slots of the stator surround a portion of the circumferential region of the rotor.

10. The dynamo as claimed in claim 1, wherein the slots of the stators are arranged in an unenclosed curve.

11. The dynamo as claimed in claim 1, wherein in the area where the slots on the stator body correspond to the rotor, there is a difference between the number of magnetic elements and the number of slots of less than or equal to six.

12. The dynamo as claimed in claim 1, wherein the number of magnetic elements of the rotor is greater than the number of slots of the stator.

13. The dynamo as claimed in claim 1, wherein the rotor surrounds the stator.

14. The dynamo as claimed in claim 1, wherein the magnetic elements are permanent magnets or electromagnets.

15. The dynamo as claimed in claim 1, wherein the dynamo receives kinetic energy from a kinetic energy source, which comprises:
a transmission device, connected to the kinetic energy source and drove thereby, wherein the rotor is connected to the transmission device and drove thereby.

16. The dynamo as claimed in claim 15, wherein the transmission device is a gearset transmission device or a wheel transmission device.

17. The dynamo as claimed in claim 15, wherein the transmission device comprises:
a first wheel, connected to the kinetic energy source and rotated thereby;
a second wheel, connected to the rotor; and
a first belt, connected to the first wheel and the second wheel to transmit the kinetic energy from the first wheel to the second wheel.

18. The dynamo as claimed in claim 17, wherein a diameter of the first wheel is smaller than a diameter of the second wheel.

19. The dynamo as claimed in claim 15, wherein the transmission device comprises:
a first wheel, connected to the kinetic energy source and rotated thereby;
a second wheel;
a first belt, connected to the first wheel and the second wheel to transmit the kinetic energy from the first wheel to the second wheel;
a third wheel, coaxially connected to the second wheel;
a fourth wheel, connected to the rotor; and
a second belt, connected to the third wheel and the fourth wheel to transit the kinetic energy from the third wheel to the fourth wheel.

20. The dynamo as claimed in claim 1, wherein the dynamo receives kinetic energy from a kinetic energy source, and a rotation speed of the rotor is slower than that of the kinetic energy source.

21. The dynamo as claimed in claim 1, wherein the dynamo receives kinetic energy from a kinetic energy source, which comprises:
a flywheel, connected to the kinetic energy source and drove thereby, wherein the rotor is connected to the flywheel and is rotated thereby.

22. The dynamo as claimed in claim 1, wherein the dynamo receives kinetic energy from a kinetic energy source, which comprises:
a transmission device, connected to the kinetic energy source and drove thereby; and
a flywheel, connected to the transmission device and drove thereby, wherein the rotor is connected to the flywheel and is rotated thereby.

23. The dynamo as claimed in claim 1, wherein the dynamo receives kinetic energy from a kinetic energy source, which comprises:
a flywheel, connected to the kinetic energy source and drove thereby; and
a transmission device, connected to the flywheel and drove thereby, wherein the rotor is connected to the transmission device and is rotated thereby.

24. The dynamo as claimed in claim 1, wherein the dynamo receives kinetic energy from a kinetic energy source, which comprises:
a first transmission device, connected to the kinetic energy source and drove thereby;
a flywheel, connected to the first transmission device; and
a second transmission device, connected to the flywheel, wherein the rotor is connected to the second transmission device and is rotated thereby.

25. The dynamo as claimed in claim 1, further comprising a housing, wherein the rotor is disposed in the housing, the stator unit is detachably disposed in the housing, and the stator unit is inserted into the housing and corresponds to the rotor.

26. The dynamo as claimed in claim 25, wherein the housing comprises a detachable groove, the stator unit is inserted into the detachable groove, and the stator unit is affixed to the housing.

27. A dynamo, receiving kinetic energy from a kinetic energy source comprising:
a rotor, comprising a rotor body and a plurality of magnetic elements, wherein each two adjacent magnetic elements have different magnetic poles; and
a stator unit, comprising at least one stator, with the stator comprising a stator body, a plurality of slots and a plurality of amature windings, wherein the slots are formed on the stator body and face the rotor, the amature windings are wound on the slot, and the slots on the stator body are arranged in an unenclosed curve; and
a transmission device, connected to the kinetic energy source and drove thereby, wherein the rotor is connected to the transmission device and drove thereby.

28. The dynamo as claimed in claim 27, wherein a rotation speed of the rotor is slower than that of the kinetic energy source.

29. The dynamo as claimed in claim 27, wherein the number of magnetic elements of the rotor is greater than the number of slots of the stator.

30. A dynamo, receiving kinetic energy from a kinetic energy source comprising:
a rotor, comprising a rotor body and a plurality of magnetic elements, wherein each two adjacent magnetic elements have different magnetic poles;
and a stator unit, comprising at least one stator, with the stator comprising a stator body, a plurality of slots and a plurality of amature windings, wherein the slots are formed on the stator body and face the rotor, the amature windings are wound on the slot, and the slots on the stator body are arranged in an unenclosed curve; and
a flywheel, connected to the kinetic energy source and drove thereby, wherein the rotor is connected to the flywheel and is rotated thereby.

31. A dynamo, receiving kinetic energy from a kinetic energy source comprising:
a rotor, comprising a rotor body and a plurality of magnetic elements, wherein each two adjacent magnetic elements have different magnetic poles; and
a stator unit, comprising at least one stator, with the stator comprising a stator body, a plurality of slots and a plurality of amature windings, wherein the slots are formed on the stator body and face the rotor, the amature windings are wound on the slot, and the slots on the stator body are arranged in an unenclosed curve;
a transmission device, connected to the kinetic energy source and drove thereby; and
a flywheel, connected to the transmission device and drove thereby, wherein the rotor is connected to the flywheel and is rotated thereby.

32. A dynamo, receiving kinetic energy from a kinetic energy source comprising:
a rotor, comprising a rotor body and a plurality of magnetic elements, wherein each two adjacent magnetic elements have different magnetic poles; and
a stator unit, comprising at least one stator, with the stator comprising a stator body, a plurality of slots and a plurality of amature windings, wherein the slots are formed on the stator body and face the rotor, the amature windings are wound on the slot, and the slots on the stator body are arranged in an unenclosed curve;
a flywheel, connected to the kinetic energy source and drove thereby; and
a transmission device, connected to the flywheel and drove thereby, wherein the rotor is connected to the transmission device and is rotated thereby.

33. A dynamo, receiving kinetic energy from a kinetic energy source comprising:
a rotor, comprising a rotor body and a plurality of magnetic elements, wherein each two adjacent magnetic elements have different magnetic poles; and
a stator unit, comprising at least one stator, with the stator comprising a stator body, a plurality of slots and a plurality of amature windings, wherein the slots are formed on the stator body and face the rotor, the amature windings are wound on the slot, and the slots on the stator body are arranged in an unenclosed curve;
a first transmission device, connected to the kinetic energy source and drove thereby;
a flywheel, connected to the first transmission device and drove thereby; and
a second transmission device, connected to the flywheel and drove thereby, wherein the rotor is connected to the second transmission device and is rotated thereby.
